(19) United States
(12) Patent Application Publication
(10) Pub. No.: US 2007/0111653 A1
(43) Pub. Date: May 17, 2007

(54) Air vent register

(75) Inventor: Masahiro Endou, Toyota-shi (JP)

Correspondence Address: BIRCH STEWART KOLASCH & BIRCH, PO BOX 747, FALLS CHURCH, VA, 22040-0747, US

(73) Assignee: HOWA PLASTICS CO, LTD.

(21) Appl. No.: 11/598,015

(22) Filed: Nov. 13, 2006

(30) Foreign Application Priority Data
Nov. 14, 2005 (JP) JP2005-328831

(51) Int. Cl. B60H 1/34

(52) U.S. Cl. 454/155

(57) ABSTRACT

An air vent register includes a front movable louver structure having a plurality of fins disposed side by side for rotation, a rear movable louver structure disposed at a rear of the front movable louver structure, the rear louver structure having a plurality of fins for rotation arranged side by side and extending orthogonally to the fins of the front louver structure, an operation knob mounted around one of the fins of the front louver structure in a slidable manner, a link mechanism linking the operation knob and the rear louver structure for rotating the fins of the rear louver structure in accordance with a sliding movement of the operation knob, and a rubber-like elastic element arranged between the operation knob and the fin of front movable louver structure equipped with the operation knob in an abutting manner to the fin and the operation knob, the elastic element comprising a projection abutting against the fin and having a through hole for increasing a deformable amount of the projection.

The present application claims priority from Japanese Patent Application No. 2005-328831 of Endou, filed on Nov. 14, 2005, the disclosure of which is hereby incorporated into the present application by reference.

### BACKGROUND OF THE INVENTION

1. Field of the Invention

The present invention relates to an air vent register used for ventilation of vehicle compartment or for an air outlet of air conditioner, and more particularly to an air vent register in which a knob is slidably mounted on one of fins in a front movable louver structure for adjusting the outlet direction of air.

2. Description of Related Art

An air vent register of this kind is known for example in JP4-082645U. This air vent register includes a horizontal movable louver structure and a vertical movable louver structure arranged one behind another in its bezel defining an airflow channel, and an operation knob movably mounted on a central fin of the horizontal louver structure located forward.

In this conventional air vent register, the operation knob mounted on the central fin of the horizontal louver structure is slidable along the fin in the axial direction or lateral direction, and is pivotable about the axis of the fin vertically together with the fin. The knob is provided at the leading end with an engaging portion adapted to engage with a vertical axis of a fin of the vertical louver structure located at the rear which axis is deviated from that of the above fin. To adjust the outlet direction of air in the lateral direction, the operation knob is slid along the fin of the horizontal louver structure laterally to swing the vertical louver structure located at the rear. To adjust the outlet direction of air in the vertical direction, the knob is pivoted vertically together with the fin of the horizontal louver structure to adjust the air outlet direction.

In order to prevent a jolt and to exhibit an adequate operating load when being slid along the fin, the operation knob of this conventional air vent register includes a pair of arms projected from opposite sides of a rear region of its body and a spring member for pressing the arms onto the horizontal louver in a rear region of the body. However, this arrangement complicates the structure of the operation knob and also increases the number of parts. In addition, since the arms and spring member are exposed at the rear side of the knob body, they become visible from the front side of the register when the knob is manipulated downward, thereby adversely affecting the appearance of the register.

An improvement was proposed by the applicant of this application as in JP2003-276428, where an air vent register includes an operation knob having a rubber-like elastic element disposed inside its body. The elastic element of the knob is pressed onto the front side of a horizontal fin so that the operation knob slides with an adequate operating load and no jolt.

However, although this operation knob of the above register exhibits a favorable operating load due to its arrangement of sliding the elastic element along the front side of the horizontal fin, in the event that a dimensional variation occurs from product to product, for example in an internal dimension of the operation knob or a width of the horizontal fin, a jolt is still liable to occur in some products in the sliding of the knob, whereby the operating load is not stable.

### SUMMARY OF THE INVENTION

The object of the present invention is to provide an air vent register whose operation knob is manipulated with a stable operating load and no jolt, while being capable of adjusting the outlet direction or air favorably.

The object of the present invention is achieved by an air vent register having the following structure:

The air vent register includes an operation knob slidably mounted around a fin of a front movable louver structure for adjusting an outlet direction of air. A rubber-like elastic element is disposed between the operation knob and the fin in such a manner as to abut against the fin and the knob. The elastic element is provided with a projection abutting against at least one of the fin or the operation knob, and the projection has a through hole for increasing a deformable amount thereof.

The rubber-like elastic element can be disposed in an interior of the operation knob to abut against the fin of the front movable louver structure.

It will also be appreciated that the operation knob includes a knob body covering a front side of the fin of the front movable louver structure, a knob cover fitted on an outer side of the knob body, and a geared section having a gear fitted to back sides of the knob body and the knob cover, and that the rubber-like elastic element is fitted to the knob body such that the projection of the elastic element contacts the fin or the operation knob.

The rubber-like elastic element may be provided with the projections at two positions in its back side and each of which projections may have a through hole running generally orthogonally to the pressing direction of the projections.

Alternatively, the rubber-like elastic element may include two projections in its back side to contact the fin and two projections in its front side to contact the operation knob whereas each of the projections formed in the front side has a through hole running generally orthogonally to the pressing direction of the projections.

With the air vent register arranged as above, if the operation knob is manipulated on the fin in a swinging manner, the fins of the front movable louver structure jointly pivot and swing to adjust the airflow direction inside the airflow channel in accordance with the manipulation angle of the knob. If the knob is slid along the fin of the front louver structure, a link mechanism such as a gear attached to the knob and linked to the rear louver structure rotates and swings the fins of the rear louver structure located behind the front structure jointly, thereby adjusting the airflow direction inside the airflow channel in accordance with the sliding range of the knob.

When swung or slid along the fin, the projection of the rubber-like elastic element disposed inside the knob body slides while pressing the fin. This arrangement will cause an adequate sliding resistance between the fin and elastic element, so that the knob will be manipulated with a favorable operating load.

Moreover, if there is a variation from product to product in such dimensions as the width of the fin or the dimension of the inner contour of the knob body, the elastic element is capable of absorbing the dimensional variation by deforming its projection having a through hole. Accordingly, the operation knob is prevented from engaging with the fin too strongly or being jolty, and a stable operating load is given to all products.

### BRIEF DESCRIPTION OF DRAWINGS

FIG. 1 is a front elevation of an air vent register embodying the present invention;

FIG. 2 is a sectional view taken along line II-II of FIG. 1;

FIG. 3 is a plan view of a horizontal fin and an operation knob;

FIG. 4 is an enlarged section taken along line IV-IV of FIG. 3;

FIG. 5 is an exploded perspective view of the operation knob and horizontal fin of FIG. 3;

FIG. 6 is an enlarged plan view of a rubber-like elastic element;

FIG. 7 is an enlarged plan view of a rubber-like elastic element of an alternative embodiment; and

FIG. 8 is a partial enlarged section of a fin and an operation knob of another alternative embodiment.

### DESCRIPTION OF PREFERRED EMBODIMENTS

Preferred embodiments of the present invention are now described below with reference to the accompanying drawings. However, the invention is not limited to the embodiments disclosedherein. Allmodifications within the appended claims and equivalents relative thereto are intended to be encompassed in the scope of the claims.

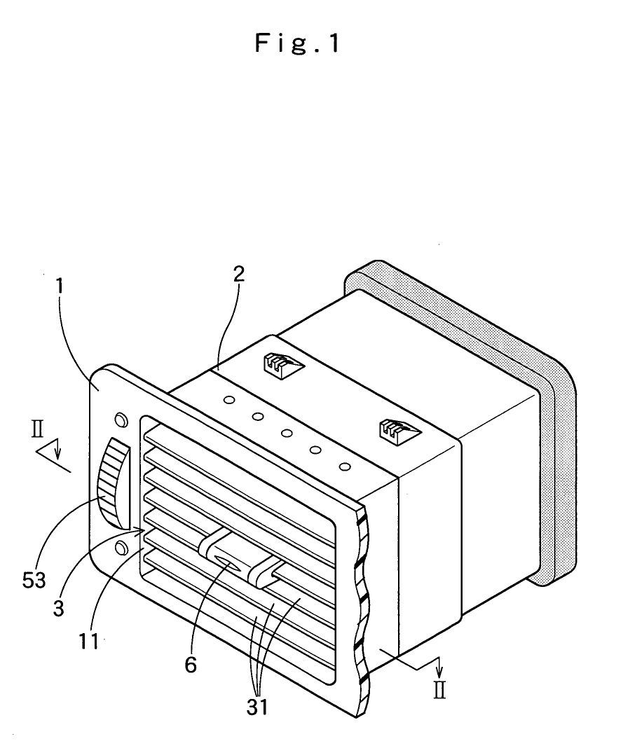

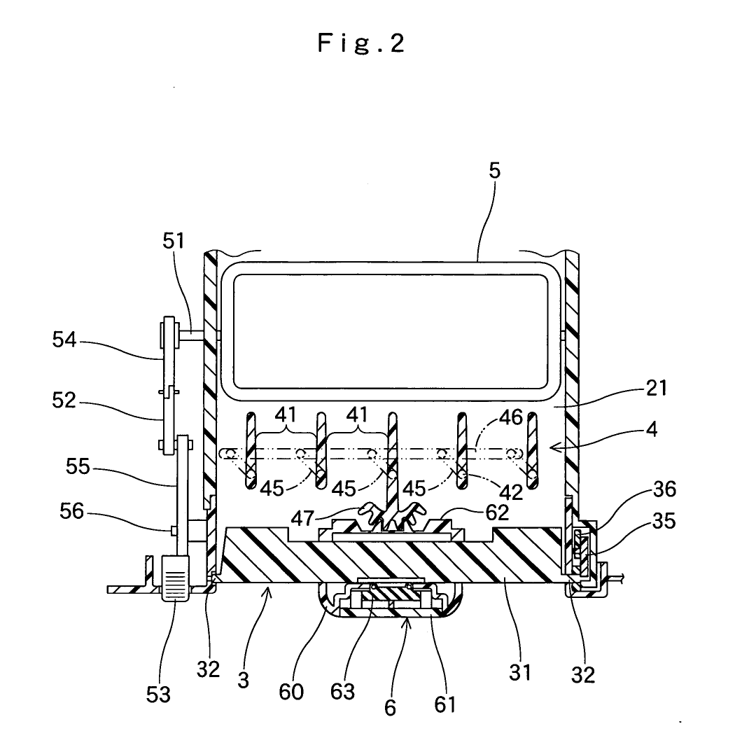

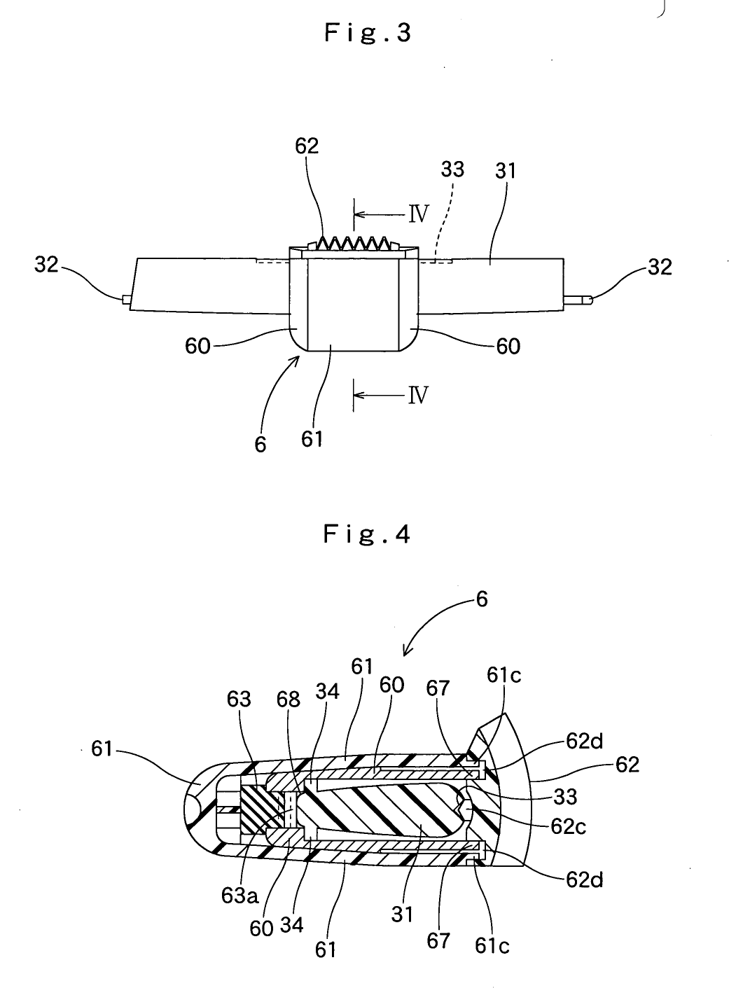

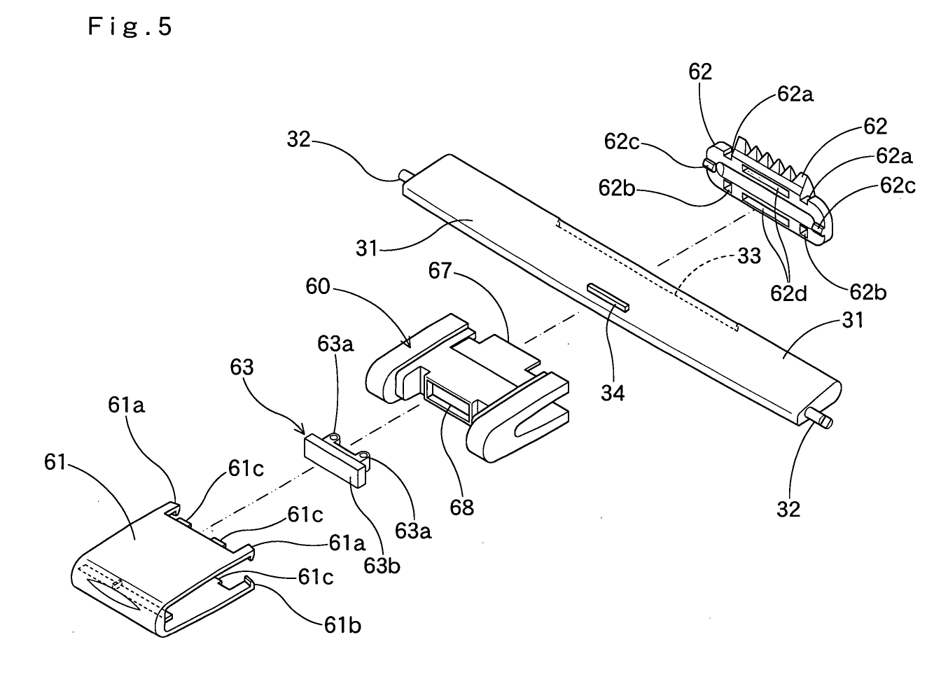

FIG. 1 is a front elevation of an air vent register embodying the present invention, and FIG. 2 is its cross section. FIG. 3 is a plan view of a horizontal fin 31 of a front movable louver structure 3, and FIG. 4 is an enlarged cross section of an operation knob 6 of the horizontal fin. FIG. 5 is an exploded perspective view of the knob 6.

In these drawings, reference numeral 1 generally denotes a bezel provided at its front with an outlet opening 11. Inside or at the backside of bezel 1 is a fitting region in which a later-described retainer 2 is fitted for connection with bezel 1. Left and right side walls of the inner side of the opening 11 are provided with bearing holes formed at predetermined intervals for receiving the horizontal fins. Bezel 1 is further provided at its left front side with an aperture where a damper knob 53 is set in.

Retainer 2 is formed into a generally rectangular duct shape, and an airflow channel 21 is provided inside the retainer 2. Retainer 2 is provided on its upper wall and lower wall in the front edge region with bearing hole for receiving vertical fins at predetermined intervals. More bearing holes are formed on side walls in a deeper region of the airflow channel 21 into which a rotary shaft 51 of damper 5 is inserted.

Front movable louver structure 3 includes a plurality of horizontal fins 31 rotatably arranged at predetermined intervals. Rotary shafts 32 of horizontal fins 31 are joined to one another by a link 36 via cranks 35. As shown in FIG. 2, shafts 32 of horizontal fins 31 are put into bearing holes formed on opposite side walls of bezel 1 and pivotally supported therein. Cranks 35 are coupled to one of opposite ends of shafts 32 of fins 31, which cranks 35 are mutually joined by the link 36, and thereby forming a link mechanism for rotating the front louver structure 3. Cranks 35 and link 36 of the link mechanism are located outside the bezel 1.

As will be described later, operation knob 6 is mounted on one of the horizontal fins 31 of the front movable louver structure 3. The fin 31 to which the knob 6 is attached is provided, on upper and lower sides in its front region, with linear projections 34 extending in the length direction of the fin 31 as shown in FIG. 5. The fin 31 is further provided at its back side with a guide groove 33 extending in the length direction of the fin 31 and having a triangular section. Guide groove 33 is to allow the knob 6 to slide there-along. Since the recess 33 has a recessed shape, it is not likely to come in sight of occupants of vehicle, and therefore, will not affect the appearance of the air vent register.

Referring to FIG. 2, a rear movable louver structure 4 includes a plurality of vertical fins 41 rotatably arranged at predetermined intervals within the retainer 2. Rotary shafts 42 of vertical fins 41 are joined to one another by a link 46 via cranks 45. Rotary shafts 42 projected from upper and lower ends of vertical fins 41 are respectively fitted in bearing holes formed on the upper and lower walls inside the retainer 2 in a rotatable manner. Cranks 45 are coupled to lower ends of lower shafts 42 of fins 41, which cranks 45 are mutually joined by the link 46. This link mechanism is disposed on a lower side of the lower wall of the retainer 2 for swinging vertical fins of the rear louver structure 4.

Moreover, as shown in FIG. 2, a central vertical fin 41 of the rear louver structure 4 is provided in its front region with a sectorial or fan-like gear 47 projecting forward. The gear 47 is adapted to engage with a geared section 62 of operation knob 6 mounted on horizontal fin 31 located at the front of gear 47. Operation knob 6 serves to transmit the lateral turning force to vertical fins 41 while being manipulated to lateral directions.

A damper 5 is disposed at a deeper region inside retainer 2 for closure of airflow channel 21. Damper 5 is provided at its opposite sides with rotary shafts 51 fitted in the shaft holes formed on side walls of retainer 2. As shown in FIG. 2, a crank 54 is secured to an end of rotary shafts 51 of damper 5, and which crank 54 is connected with a connecting rod 52.

A damper knob 53 is pivotally supported on a side wall of retainer 2 by a shaft 56. A lever-like link 55 integral with damper knob 53 is coupled to the leading end of connecting rod 52 whose another end is joined with crank 54 fixed to rotary shaft 51 of damper 5. A front region of damper knob 53 projects forward from an opening for the damper knob formed on bezel 1. If the damper knob 53 is turned upward or downward around the shaft 56, damper 5 rotates via link 55, connecting rod 52 and crank 54 and closes airflow channel 21.

As best shown in FIG. 2, operation knob 6 for adjusting orientations of the front louver structure 3 and rear louver structure 4 is mounted around a specific horizontal fin 31 of the front louver structure 3 in a slidable manner. Referring to FIG. 5, knob 6 includes a knob body 60 configured to cover the fin 31, a knob cover 61 attached to the center of outer side of the knob body 60 in such a manner as to cover the body 60 from outside, a geared section 62 mounted on the back side or rear side of knob body 60, and a rubber-like elastic element 63 arranged inside the body 60.

Referring to FIG. 5, knob body 60 has such a generally U-shaped side view as covers the front side, top side and lower side of horizontal fin 30. Knob body 60 is provided with a pair of plate-like fitting sections 67 projected from top and lower ends of its back side. It also includes at the center of its inner side a rectangular hole 68 running through to the back side for receiving rubber-like elastic element 63. As will be described later in detail, elastic element 63 is made from silicone rubber or the like, and has projections 63 a adapted to contact and press the front side of horizontal fin 31 with an adequate sliding resistance. As shown in FIG. 4, in the vicinity of the elastic element 63, knob body 60 includes guide regions in upper and lower regions of its inner side. Linear projections 34 formed in the front region of the horizontal fin 31 fit to the guide regions in a slidable manner, whereby operation knob 6 is guided in the lateral direction within a predetermined range.

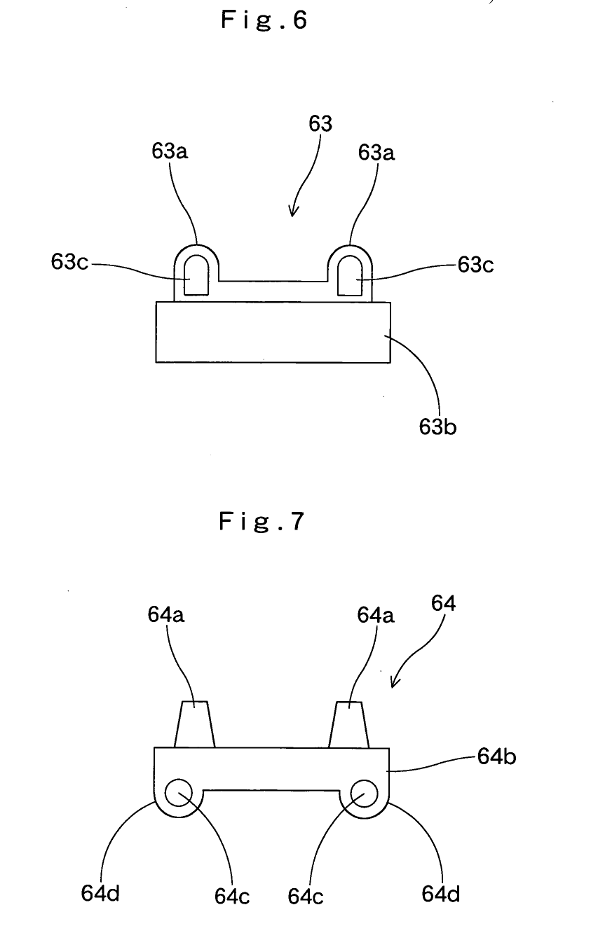

Rubber-like elastic element 63 is molded from oil impregnated silicone rubber or the like having an adequate elasticity and preferable sliding resistance. Its main body is a rectangular flat portion 63b having a rectangular plate shape as shown in FIGS. 5 and 6. In backside of the flat portion 63b are two projections 63a each having a through hole 63c. Each of the through holes 63c runs through the projection 63a orthogonally to the projecting direction of projection 63a i.e. Orthogonally to the pressing direction of projection 63a. These two projections 63a are adapted to be inserted into the rectangular hole 68 formed at the center of knob body 60. Rectangular hole 68 runs through the inner region of knob body 60, and leading ends of projections 63a of elastic element 63 set in the rectangular hole 68 contact and press the front side of horizontal fin 31 inserted into knob body 60.

As shown in FIG. 5, knob cover 61 is mounted around the front, top and lower sides of the knob body 60 in a generally center location of knob body 60. Knob cover 61 is molded from hard synthetic resin into such a shape as a plate bent into a generally U-shape. Knob cover 61 is integrally molded to include following parts: a pair of upper hook portions 61a projecting from opposite edges of upper region in back side; a pair of lower hook portions 61b projecting from opposite edges in lower region in back side; and two pairs of lugs 61c projecting from upper and lower middle regions of back side to be set in later-described grooves 62d of geared section 62.

Geared section 62 is assembled to the back side of knob body 60 to cover the back side of horizontal fin 31. It is provided in back side with gear tooth arranged vertically at predetermined intervals. As shown in FIG. 5, geared section 62 includes triangular projections 62c in opposite ends of its front side to be retained by guide groove 33 formed in the back side of horizontal fin 31 when geared section 62 is mounted on fin 31. The triangular shape of each projection 33 as viewed from side helps reduce the risk of leaning or deformation which would otherwise occur in the molding work, thereby conducing to precise molding.

Since the triangular projections 62c are adapted to engage with guide groove 33 having a triangular section, some dimensional errors in the projections 62c or recess 33 will not hinder the smooth engagement of the projections 62c and recess 33. Accordingly, triangular projections 62c will engage with guide groove 33 favorably, so that operation knob 6 will slide on horizontal fin 31 smoothly.

Geared section 62 further includes recessed retaining regions 62a for retaining upper hook portions 61a of knob cover 61 in opposite sides of its upper inner region, and rectangular retaining holes 62b for retaining lower hook portions 61b of knob covert 61 in opposite sides of its lower inner region. In addition, geared section 62 includes in its front side a pair of grooves 62d arranged one above and parallel with the other for receiving plate-like lugs 61c formed in the back side of knob cover 61 and plate-like fitting sections 67 formed in the back side of knob body 60.

In order to assemble operation knob 6, firstly, rubber-like elastic element 63 is inserted into rectangular hole 68 of knob body 60 from front side in such a manner as to put a pair of its projections 63a therein as shown in FIG. 5, and then knob cover 61 is mounted around knob body 60 on the center. Subsequently, this assembly of knob body 60, knob cover 61 and elastic element 63 is assembled with the specific horizontal fin 31 in such a manner as to cover the outer circumference of the fin 31 from the front side as shown in FIG. 5, and then geared section 62 is assembled thereto from back side.

More specifically, upper hook portions 61a formed in opposite edges of upper region of knob cover 61 are retained in the retaining recesses 62a formed in opposite sides of upper region of geared section 62, whereas lower hook portions 61b formed in opposite edges of lower region of knob cover 61 are inserted and retained in retaining holes 62b formed in opposite sides of lower region of geared section 62. Operation knob 6 is thus assembled. At this time, as shown in FIG. 4, lugs 61c of knob cover 61 and plate-like fitting sections 67 of knob body 60 are fitted in grooves 62 of geared section 62, which serves to positioning of knob body 60 and knob cover 61 against the geared section 62. Accordingly, knob body 60 and knob cover 61 are assembled with geared section 62 accurately.

By this assembling work, as shown in FIG. 4, triangular projections 62c engage with guide groove 33 of the horizontal fin 31, guide regions formed inside knob body 60 abut against linear projections 34 of the fin 31, whereas projections 63a of rubber-like elastic element 63 contact and press the front side of the fin 31. Hence operation knob 6 is mounted on the fin 31 in a slidable manner in the lateral or length direction, with an adequate operating load.

The air vent register having above structure is mounted on an instrument panel or dashboard in a vehicle compartment while being connected to a not-shown airflow duct at the end of retainer 2. An air fed from the duct is discharged through the air flow channel 21 in the retainer 2 and outlet opening 11.

When a vehicle occupant desires to adjust the outlet direction of air in the vertical direction, operation knob 6 of front louver structure 3 is manipulated upward or downward. If operation knob 6 is pivoted upward or downward, the horizontal fin 31 equipped with knob 6 rotates around rotary shaft 32 vertically as shown in FIG. 2, and then the rotary force is transmitted via cranks 35 and link 36 to other horizontal fins 31 such that the fins 31 rotate around respective shafts 32. Thus the vertical direction of the horizontal fins 31 is jointly changed to adjust the air-outlet direction in the vertical direction.

When the outlet direction of air is desired to change in the horizontal or lateral direction, operation knob 6 is manipulated to the left or right direction. If knob 6 is moved to left or right, it slides on the horizontal fin 31. At this time, since an adequate operating load is exhibited due to the frictional resistance between the projections 63a of rubber-like elastic element 63 and the front side of fin 31, operation knob 6 is manipulated with favorable operating load and excellent operational feeling to adjust the air-outlet direction.

With respect to the elastic element 63 whose projections 63a contact the horizontal fin 31, the through hole 63c formed in each projection 63a makes the projection 63a more deformable, that is, increases a deformable amount of the projection 63a. With this arrangement, if the width of horizontal fin 31, the size of elastic element 63 or the dimension of rectangular hole 68 of knob body 60 varies from product to product, three-dimensional variation of those parts is absorbed by deformation of the projections 63a. Accordingly, the operating load from product to product is made consistent, that is, the operating load is stabilized.

If operation knob 6 is moved in the lateral direction, gear tooth of geared section 62 of operation knob 6 rotates the sectorial gear 47, so that the central fin 41 of the rear louver structure 4 having the gear 47 rotates around its shaft 42 laterally, and then the rotary force is transmitted via cranks 45 and link 46 to other vertical fins 41 such that the fins 41 rotate around respective shafts 42. Thus the lateral direction of the vertical fins 41 is jointly changed to adjust the air-outlet direction in the lateral direction.

As described above, therefore, since the rubber-like elastic element 63 arranged inside knob body 60 slides on the front side of horizontal fin 31 while pressing the same, an adequate sliding resistance is generated between the fin 31 and elastic element 63, so that the operation knob 6 is slid favorably with an adequate operating load. Moreover, since the projections 63a of elastic element 63 are capable of absorbing variations in the width of horizontal fin 31 or the dimension of inner contour of knob body 60 from product to product by its deformation, operation knob 60 is prevented from engaging with the fin 31 too strongly or from becoming jolty. Therefore, stable operating load is given to all products.

FIG. 7 illustrates a rubber-like elastic element 64 in an alternative embodiment. Elastic element 64 is molded from oil impregnated silicone rubber or the like having an adequate elasticity and preferable sliding resistance as the above-described elastic element 63. Its main body is a cuboid portion 64b having a rectangular plate shape. Cuboid portion 64b is provided in its front side with two projections 64d in addition to two projections 64a formed in its back side. Front projections 64d each has a through hole 64c inside thereof and which hole 64c runs through the projection 64d orthogonally to the projecting direction or projection 64d i.e. Orthogonally to the thickness direction of projection 64d. Two projections 64a in the back side are adapted to be inserted into the rectangular hole 68 formed at the center of knob body 60.

As in the previous embodiment, two projections 64a of elastic element 64 are inserted into the rectangular hole 68 formed through knob body 60 so that leading ends of projections 64a contact and press the front side of horizontal fin 31 set in knob body 60. In this elastic element 64, too, since the hole 64c is formed through each of the projections 64d, its deformable amount when pressed is greater than an instance where the projection 64d is solid. Accordingly, elastic element 64 is capable of absorbing dimensional variation in parts of fin 31 or knob 6 by its deformation, so that stable operating load is given to all products.

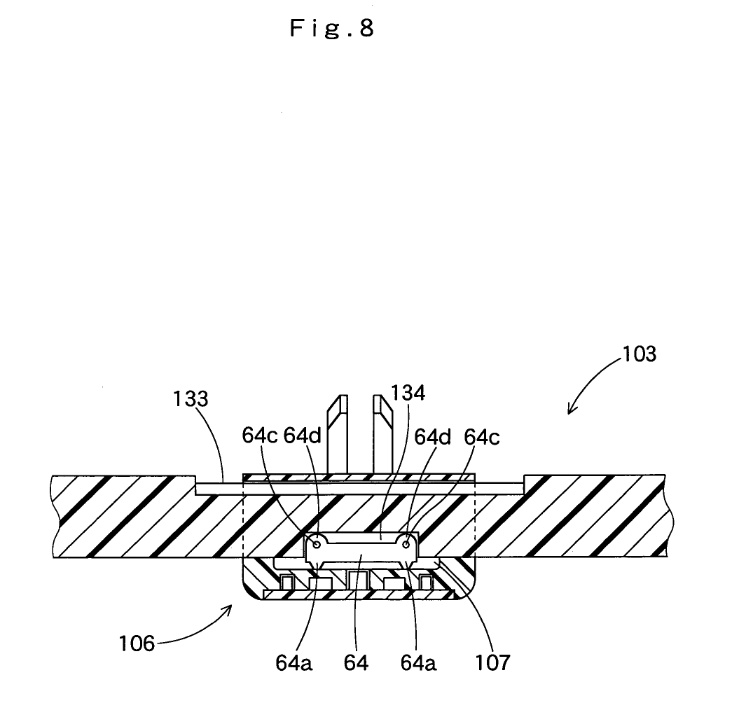

FIG. 8 illustrates a horizontal fin 103 and operation knob 106 in another alternative embodiment. In this embodiment, horizontal fin 103 is provided in a generally center of its front edge region with a recess 134, whereas in the opposite side from the recess 134 or in a rear edge region of fin 103 is a guide groove 133. Rubber-like elastic element 64 is set in the recess 134 so that two projections 64d formed on one side of element 64 abut against the inner surface of the recess 134.

Elastic element 64 is set in the recess 134 so that two projections 64a formed on the other side project forward of the horizontal fin 103 from the recess 134. Operation knob 106 is mounted around the horizontal fin 103 in a slidable manner so that knob 106 covers the elastic element 64 thoroughly. Operation knob 106 is provided in its front internal region with a recessed portion 107 running in the lateral direction i.e. in the length direction of fin 103. Two projections 64a of elastic element 64 contact the inner surface of the recessed portion 107.

With these horizontal fin 103 and operation knob 106, if the knob 106 is slid along the horizontal fin 103, knob 106 moves against the stationary elastic element 64. Thus an adequate sliding resistance is generated between the inner surface of recessed portion 107 of knob 106 and projections 64a of elastic element 64, so that the operation knob 106 slides favorably with an adequate operating load. Furthermore, as the previous embodiments, since the projections 64a of elastic element 64 are capable of absorbing variations in the width of fin 103 or the dimension of inner contour of knob 106 from product to product by their deformation, operation knob 106 is prevented from engaging with the fin 103 too strongly or from becoming jolty. Therefore, stable operating load is given to all products.

The air vent register of the present invention should not be limited to the embodiments described above. For example, it may also be embodied as follows:
1. In the foregoing embodiments, a geared section formed on back side of operation knob engages with a sectorial gear formed on a vertical fin of the rear louver structure such that the engagement serves to rotate the rear louver structure when the operation knob is manipulated. However, the operation knob and vertical fin may be connected by a link so as to rotate the rear louver structure.
2. Although the elastic element is located in a front region of a horizontal fin in the foregoing embodiment, it may be disposed in a rear region of the operation knob so it contacts with the back side of horizontal fin.
3. Although the operation knob in the foregoing embodiments are assembled by attaching a geared section to the back side of knob body, the operation knob may be composed of upper and lower split parts and is so mounted on a fin by fitting the upper and lower parts to each other as to cover the upper side and lower side of the fin.
4. In the foregoing embodiments, the operation knob is composed of a knob body, a knob cover, and a geared section which parts are assembled to cover the horizontal in. However, the operation knob may be constructed as an integrally molded part provided with a recessed portion or through hole for inserting the horizontal fin, such that the fin is rotated or put in in such a manner as to insert the fin in the recessed portion or through hole to mount the knob on the fin.
5. Furthermore, in the foregoing embodiments, the front movable louver structure has horizontal fins whereas the rear movable louver structure has vertical fins. However, the front louver structure may be provided with vertical fins whereas the rear louver structure with horizontal fins so that the operation knob is mounted on a vertical fin of the front louver structure.

What is claimed is:

1. An air vent register comprising:
a front movable louver structure having a plurality of fins arranged at predetermined intervals for rotation;
a rear movable louver structure disposed at a rear of the front movable louver structure, the rear movable louver structure having a plurality of fins for rotation arranged at predetermined intervals and orthogonally to the fins of the front movable louver structure;
an operation knob mounted around one of the fins of the front movable louver structure in a slidable manner;
a link mechanism linking the operation knob and the rear movable louver structure for rotating the fins of the rear movable louver structure in accordance with a sliding movement of the operation knob; and
a rubber-like elastic element arranged between the operation knob and the fin of front movable louver structure equipped with the operation knob in an abutting manner to the fin and the operation knob, the elastic element comprising a projection abutting against at least one of the fin or the operation knob and having a through hole for increasing a deformable amount of the projection.

2. The air vent register according to claim 1, wherein the rubber-like elastic element is disposed in an interior of the operation knob to abut against the fin of the front movable louver structure.

3. The air vent register according to claim 1, wherein:
the fin of the front movable louver structure includes a recessed portion;
the rubber-like elastic element is arranged inside the recessed portion and contact with the operation knob.

4. The air vent register according to claim 2, wherein:
the operation knob comprises a knob body covering a front side of the fin of the front movable louver structure, a knob cover fitted on an outer side of the knob body, and a geared section having a gear attached to back sides of the knob body and the knob cover; and
the rubber-like elastic element is coupled to the knob body such that the projection of the elastic element contacts the fin or the operation knob.

5. The air vent register according to claim 4, wherein:
the rubber-like elastic element comprises the projections at two positions in a back side thereof; and
each of the projections has a through hole running generally orthogonally to a pressing direction of the projections.

6. The air vent register according to claim 4, wherein:
the rubber-like elastic element comprises two projections in a back side thereof to contact the fin and two projections in a front side thereof to contact the operation knob; and
each of the projections formed in the front side has a through hole running generally orthogonally to a pressing direction of the projections.
